(19) United States
(12) Patent Application Publication
(10) Pub. No.: US 2014/0152844 A1
(43) Pub. Date: Jun. 5, 2014

(54) BLACK LEVEL CALIBRATION METHODS FOR IMAGE SENSORS

(71) Applicant: SiOnyx, Inc., Beverly, MA (US)

(72) Inventor: Jutao Jiang, Tigard, OR (US)

(21) Appl. No.: 13/931,593

(22) Filed: Jun. 28, 2013

Related U.S. Application Data
(60) Provisional application No. 61/704,284, filed on Sep. 21, 2012.

(51) Int. Cl. H04N 17/00; H04N 5/374

(52) U.S. Cl. CPC H04N 17/002; H04N 5/374
USPC 348/187

(57) ABSTRACT

A technology is described for calibrating a black level in an image sensor. The technology provides devices, systems and methods for calculating a black level value, where in one aspect, an image data set can be received from an optical black pixel region of an image sensor. A minimum and a mean value can be calculated for the image data set. Thereupon, image thresholding of the image data set can be performed that produces a binary image segmentation of the image data set and a global threshold value can be set to the binary image segmentation that is black. A function can then be performed that determines light corruption in the image data set, and if light corruption is detected, then the image data set can be sorted and a median value can be calculated for a bottom percentage of the sorted image data set and provided as a black level baseline value.

### PRIORITY DATA

This application claims the benefit of U.S. Provisional Patent Application Ser. No. 61/704,284, filed on Sep. 21, 2012, which is incorporated herein by reference.

### BACKGROUND

Complementary metal-oxide semiconductor (CMOS) sensors typically have an array of pixels with a portion that may be covered with a light shield (e.g., metal materials, black opaque materials, or the like). The light shield can be used to block or prohibit light from reaching the photodiode section of pixels that are covered by the light shield. The pixels covered by the light shield are normally called “optical black pixels,” while the remaining unshielded pixels are normally called “active array pixels.” Optical black pixels can be used for various correction calculations, such as black level calibration calculations, column fixed-pattern-noise calculations, row temporal noise calculations, etc. For a black level calibration calculation, the imaging system normally calculates an average value for a pixel signal. An output value from the black level calibration calculation can be subtracted from the output values from the active array pixels (i.e., used for imaging) and used for a variety of purposes. For example, the output value of the black level calibration calculation can be used to track the imaging system's dark level shift related to exposure time, sensor gain, and sensor temperatures. Without subtraction of dark level, the output image can appear to be “washed out” at high temperatures or long exposure times.

An optical black pixel is traditionally intended to not detect incident light. However, as a limitation of traditional sensor design, optical black pixels can be corrupted by high intensity incident light. For example, a back-side-illuminated (BSI) sensor may be constructed by removing the bulk of the device substrate and bonding the remaining thin device layer to a carrier wafer, in some cases with an oxide layer located at the bonding interface via known bonding techniques. When high intensity incident light with rich near-infrared (NIR) content impinges upon the boundary between an active pixel array (no light shield) and the optical black pixels, the light can scatter back from the bonding interface (or metal routing) and propagate horizontally into the optical black pixel region. The signal output from optical black pixels in such cases can be “artificially” very high, and therefore may be corrupted. Light corruption can occur even if an infrared (IR) cut filter is in place, due to the fact that most filter blocking efficiencies may not be ideal. Additionally, if a sensor is designed for NIR applications, IR filters are generally not used. Moreover, for front-side-illuminated (FSI) sensors, the light corruption of an optical black pixel can also occur, particularly when the final die thickness is reduced for packaging.

### SUMMARY

Accordingly, the present disclosure provides systems and methods for calibrating optical black pixels in an imaging system. In one aspect, for example, an image device may include a camera housing wherein an imaging system of the present technology can be implemented. An aspect of the imaging system can include, for example, a processor accessible to an image sensor from which an image data set can be received and processed. The imaging system can also include a memory device comprising instructions that, when executed by the processor, cause the processor to execute certain modules and/or services. One example of a module that can be included in the imaging system is a black level calibration module. The black level calibration module can be programmed to include, logic that calculates a minimum and a mean for an image data set received from an optical black pixel region of the image sensor; logic that performs image thresholding of the image data set and sets a global threshold value equal to a binary image segmentation that is black; logic that determines light corruption as a function of the global threshold value, the minimum, the mean, and a detection threshold; logic that performs image data segmentation of the image data set that has light corruption and then removes image data having a value greater than the global threshold value; and logic that provides to the imaging system a black level baseline value from the image data segmented from the image data set that does not contain light corruption.

Such an imaging system can further include a black level calibration module containing logic that can provide a black level baseline value from the image data segmented from the image data set that does not contain light corruption by sorting the image data in ascending order and calculating a black level median value using a bottom percentage of the sorted image data. In some aspects of the imaging system, a black level can be calibrated for a video image by logic executed in the black level calibration module that can place a black level median value into a first-in-first-out (FIFO) data structure and calculate a running average value using the black level median values contained in the FIFO data structure.

In another aspect of the present disclosure, methods disclosed herein can reduce or eliminate artificially high black level signals output by an image sensor to an imaging system. Such a method can include receiving an image data set from an optical black pixel region of an image sensor and calculating a minimum value and a mean value for the image data set. in one aspect, a maximum value and a median value can also be calculated. In one aspect, the method can further include performing image smoothing of the image data set with a low pass filter. Performing image smoothing can improve the detection of light corruption and therefore improve the robustness of a black level baseline value. For example, image smoothing can reduce image noise (i.e., random variation of brightness or color variation) by applying a smoothing filter, also referred to as a low pass filter. Many different implementations of low pass filters exist. One example of a low pass filter is a smoothing linear filter that outputs a value for a center pixel in a 3×3 grid of pixels in an image. The value for the center pixel is determined by calculating an average of the pixels surrounding the center pixel in the 3×3 pixel grid. After the minimum value and the mean value have been calculated, the method can then perform image thresholding of the image data set that results in a binary image segmentation of the image data set. A global threshold variable can then be set to a value equal to the binary image segmentation that is black. Light corruption can then be determined as a function of the global threshold value, the minimum value, the mean value, and a detection threshold value (i.e., a value determined by testing various image sensors under varying light conditions that result in light corruption). In one aspect, the function may detect light corruption in the optically black region of the image sensor when all of the following conditions are met: (1) that the absolute threshold value minus the mean value is greater than the detection threshold; (2) that the global threshold value is greater than zero; and (3) that the global threshold value is greater than the minimum value. After determining whether light corruption may be present, image data segmentation can be performed on the image data set that has light corruption. A black level baseline value can be provided to the imaging system from the image data set segmented from the image data set that has light corruption.

in another aspect, when segmenting the image data set that has light corruption, image data that has a value greater than the global threshold value can be removed from the image data set, the image data set can then be sorted in ascending order and a black level median value can be calculated using a bottom percentage of the image data set. In one aspect, the bottom percentage of the image data set can be a percentage within a range of about 10% to about 20%.

In an aspect where image data may be for a video image, a method can further include placing a black level median value into a first-in-first-out (FIFO) data structure and calculating a running average value for a number of black level median values within the FIFO data structure. The running average value can then be provided to the imaging system as a black level baseline value.

In yet another aspect of the present disclosure, a method is provided for the case where no light corruption is detected in an image data set. In one aspect, for example, the image data set can be sorted in ascending order and a top percentage of the image data set can be removed. A bottom percentage of the image data set can also be removed and then a median value can be calculated for the image data set that is remaining after removing the top and bottom percentage of image data from the image data set. The median value can then be provided as a black level baseline value. In one aspect, the top percentage of the image data set removed can be a percentage within the range of about 5% to about 20%. In another aspect, the bottom percentage of the image data removed from the image data set can be a percentage within the range of about 5% to about 20%.

### BRIEF DESCRIPTION OF THE DRAWINGS

For a fuller understanding of the nature and advantage of the present disclosure, reference is made to the following detailed description of embodiments herein in connection with the accompanying drawings, in which:

FIG. 1 is a photograph depicting light corruption of optical black pixels according to an exemplary embodiment of the present disclosure;

FIG. 2 is a block diagram depicting an imaging system for calibrating black levels in an image sensor in accordance with one aspect of the present disclosure;

FIG. 3 is a block diagram depicting a module used to calculate a black level baseline value in accordance with another aspect of the present disclosure;

FIG. 4 is a diagram of a CMOS image sensor that includes a module used to calculate a black level baseline value in accordance with one aspect of the present disclosure;

FIG. 5 is a flow diagram of a method for calibrating a black level in an image sensor in accordance with one aspect of the present disclosure;

FIG. 6 is a diagram of a method for calculating a running average of black level baseline values in accordance with another aspect of the present disclosure; and

FIG. 7 is a block diagram illustrating an example of a camera device in accordance with one aspect of the present disclosure.

### DETAILED DESCRIPTION OF THE INVENTION

Before the present disclosure is disclosed and described, it is to be understood that this invention is not limited to particular structures, process steps, or materials disclosed herein, but is extended to equivalents thereof as would be recognized by those of ordinarily skill in the relevant arts. It should also be understood that terminology employed herein is used for the purpose of describing particular embodiments only and is not intended to be limiting.

### Definitions

The following terminology will be used in accordance with the definitions set forth below.

It should be noted that, as used in this specification and the appended claims, that singular forms “a” and “the” include plural referents unless the context clearly dictates otherwise. Thus, for example, reference to “a data set” includes one or more of such data sets, and reference to “the video image” includes reference to one or more such video images.

As used herein, the term “substantially” refers to the complete or nearly complete extend or degree of an action, characteristic, property, state, structure, item, or result. For example, an object that is “substantially” enclosed would mean that the object is either completed or nearly completely enclosed. The exact allowable degree of deviation from absolute completeness may in some cases depend on the specific context. However, generally speaking the nearness of completion was obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint.

As used herein, the term “black level” is used to refer to an electrical signal level provided by one or more pixels when the pixels do not detect any light, from visible light to rich near-infrared light (NIR) from any direction.

As used herein, the term “image thresholding” refers to any one of a variety of methods that segment an image into a binary image, wherein the image is segmented into a black and white image.

As used herein, the term “global threshold” refers to a variable that can be used to compare with pixel values and to then set a pixel value based on the comparison. For example, a pixel value having a value greater than or equal to the global threshold value can be set to “1” (e.g., white), and a pixel value having a value less than the global threshold value can be set to “0” (e.g., black).

As used herein, a plurality of items, structural elements, compositional elements, and/or materials may be presented in a common list for convenience. However, these lists should be construed as though each member of the list is individually identified as a separate and unique member. Thus, no individual member of such list solely based on their presentation in a common group without indications to the contrary.

Concentrations, amounts and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within the range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or maximum. Furthermore, such an interpretation should apply regardless of the breadth or range of the characteristics being described.

This same principle applies to ranges reciting only one numerical value as a minimum or a maximum. Furthermore, such an interpretation should apply regardless of the breadth of the range or the characteristics being described.

### The Disclosure

The present disclosure provides image sensing devices, systems and methods for altering images captured by the image sensing devices. More specifically, the systems and methods of the present disclosure are directed towards calibrating the black levels of the pixel regions of an image sensing device.

As was stated above, an image sensor can contain optically black pixels that are shielded from incident light. These optically black pixels can be used as reference points to create a black level baseline for a given image that the imaging system can use to calibrate the black levels of the image data gathered by the active pixels. For example, a black level baseline can be defined as a level of brightness detected by the optically black pixels. The black level of an image can be calibrated so that the displayed black value is at least substantially true to the black information captured by the optically black pixels. If the black level is not correctly calibrated, black value information within the image could be displayed as a value different from black, such as gray. One concern is that the data obtained from the optically black pixels can be corrupted, and thus not represent the true black level value, if light at high intensity impinges upon active pixels near the optically black pixels, and that such light is picked up by the optically black pixels due to leakage and/or cross talk from these active pixels. For example, because blue and green wavelengths can be absorbed within the first couple of microns of the epilayer, black level corruption may be worse for longer light wavelengths (e.g., red wavelengths, infrared light) were the light may not be readily absorbed and the light can be scattered and propagate in an imaging device where the light can be absorbed by the optically black pixels.

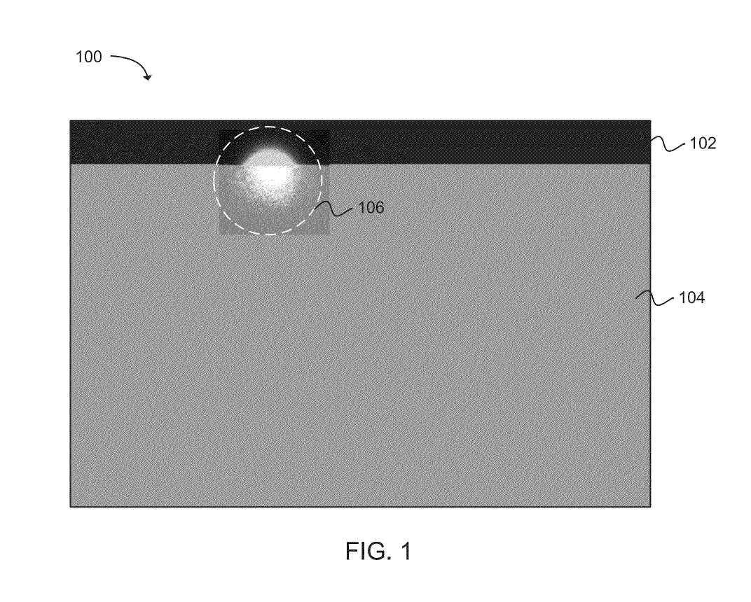

FIG. 1 is an exemplary illustration representing an image 100 captured by a CMOS image sensor showing black pixel corruption. It should be noted that FIG. 1 is an illustration providing a visual representation of black level corruption by showing readout data from both active pixels and optically black pixels. Normally, data from optically black pixels would not be provided in an image produced by an imaging device. In FIG. 1, optically black pixels 102 are located at the top several rows of active pixels 104. Optically black pixels can be shielded from direct light by a metal shield or a black opaque material enabling the optically black pixels 102 to produce an image data set that can be used as a black level baseline. The image 100 also shows a region of pixels 106 that have been exposed to a high level of light. A strong light source, such as a camera flash, captured by the CMOS image sensor can, in some circumstances, propagate into the optically black pixels 102 and cause light corruption in the image data set produced by the optically black pixels 102. For example, in one aspect light corruption can be caused by light leakage from the neighboring active pixels 104 to the optically black pixels 102. For instance, light can be scattered or propagated from the active pixels 104 to the optically black pixels. As a specific example, where a metal shield may be coupled to an oxide or silicone material and used to shield light from impinging upon the optically black pixels 102, the oxide or silicon material can act as a waveguide and the metal shield can act as a reflecting boundary that helps propagate the light underneath the metal shield to the optically black pixels 102. FIG. 1 shows that, within the region of pixels 106, a number of optically black pixels 102 have been exposed to a high level of light, which in turn can result in a black level baseline where the black level is incorrectly calibrated. The method of the present disclosure can detect and reduce the amount of light corruption in the image data set produced by the optically black pixels 102.

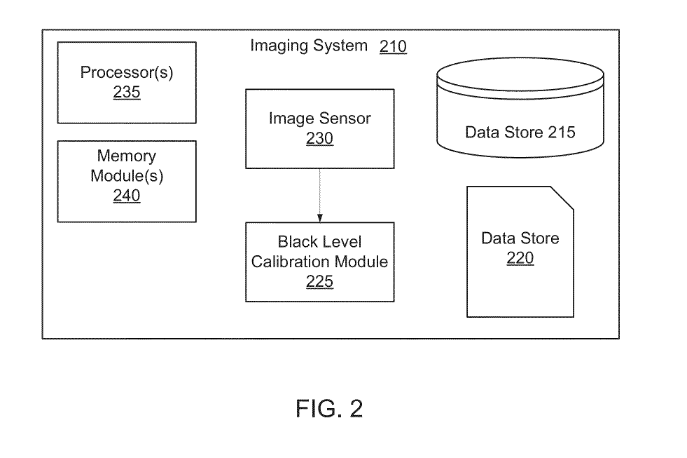

FIG. 2 illustrates an example imaging system 210 that can be configured to calibrate black levels in an image sensor 230. The imaging system 210 can be included within an imaging device, such as for example, a digital camera or a video camera. In addition, the imaging system can be included within a hybrid camera device, such as a cell phone, smart phone, digital music player, tablet device, a computing system that can be connected to an external camera device (e.g., webcam), and the like, including appropriate combinations thereof. The imaging system 210 can include an image sensor 230, such as a complementary metal oxide semiconductor (CMOS) image sensor or a charge coupled device (CCD) image sensor that is accessible to a processor 235 and memory 240. The image sensor can convert an optical image into an electronic signal that can be read by various components included in the imaging system 210.

Operations can be computed in the imaging system 210 using certain services and/or modules that can be executed on within the imaging system 210 to perform desired functions for the present technology. In one configuration, the imaging system 210 can include a black level calibration module 225 and other services, processes, systems, engines, or functionality not discussed in detail herein. The black level calibration module 225 can be configured to receive an image data set from an optically black region of the image sensor 230 and execute logic that results in a black level baseline value for an image captured by the image sensor 230.

The imaging system 210 can contain various processes and/or other functionality that can be executed on one or more processors 235 that are in communication with one or more memory modules 240 according to various examples. Various data, such as image data can be stored in a data store 215 and 220 that may be accessible to the imaging system 210. The term “data store” can refer to any device or combination of devices capable of storing, accessing, organizing and/or retrieving data, which may include any combination and number of data storage devices. Included may be storage devices such as volatile or non-volatile RAM (e.g., secure digital (SD) card), optical media, or hard-drive type media. The data store 215 and 220 may be representative of a plurality of data stores as can be appreciated.

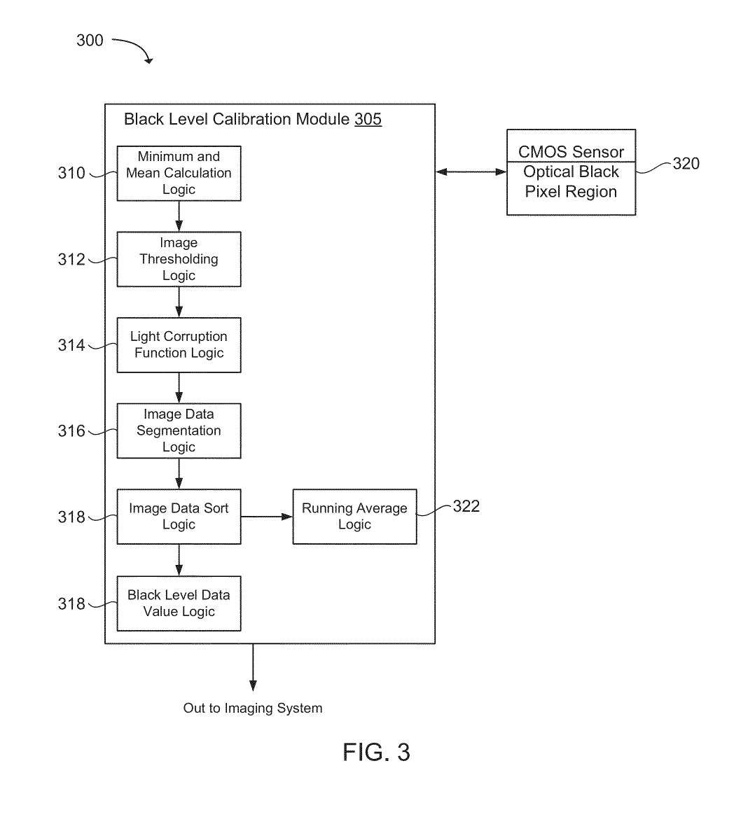

FIG. 3 is a block diagram illustrating one aspect of an imaging system 300 that includes a black level calibration module 305. Included in the black level calibration module 305 is logic that can determine a black level baseline value from an image data set. In one aspect, the logic executed by the black level calibration module 305 can be executed in the order indicated in FIG. 3, but as can be appreciated, a different order of execution may be used to achieve the same or similar results. After receiving an image data set from the optical black pixel region of a CMOS image sensor 320, the black level configuration module 305 executes logic that can determine a black level baseline value for an image captured by the CMOS sensor 320 using the image data set. The black level calibration module 305 may first calculate a minimum value for the image data set and a mean value for the image data set, as in block 310. The minimum value and the mean value can be used in a function to determine whether light corruption in an image captured by the CMOS image sensor 320 may be present.

In block 312, logic can then be executed that performs image thresholding of the image data set. Image thresholding, in one example, can be used to create a binary image (i.e., black and white) from a grayscale image. After performing image thresholding of the image data set, a global threshold variable can be set to the value of the binary segmentation of the image data set that is black.

Having set the global threshold variable to a black value, in block 314 logic can be executed to perform a function that determines light corruption within the image data set. In one aspect, the function can be a function of a variety of variable, including those variables determined above, namely, the global threshold value, the minimum value, and the mean value. In one aspect, however, the logic can be a function of the detection threshold value. The detection threshold value can be a value that is based upon light condition tests for a particular image sensor. For example, a detection threshold value may be based on light condition tests with a particular pixel type, pixel size, pixel stack height, a thickness of a substrate used for an image sensor, a textured region used for an image sensor, as well as other factors. Various light conditions can be tested with each image sensor type and from the tests a detection threshold value can be determined.

In one aspect of the present disclosure, for example, the function can determine whether light corruption may be present in the image data set when a set of conditions are met. An exemplary set of conditions can include: (1) the absolute global threshold value minus the mean value is greater than the detection threshold; (2) the global threshold value is greater than zero; and (3) the global threshold value is greater than the minimum value. In one aspect, if the above three conditions are met, then the image captured by the CMOS image sensor 320 may have light corruption in the optically black region. If all of the above conditions are not met, then it is unlikely that light corruption is detected in the image.

In a case where light corruption may be detected in the image data set, then as in block 316, logic can be executed that performs image data segmentation. Namely, image data within the image data set that has a value that is larger than the global threshold value can be separated or removed from the image data set. Then, as in block 318, logic can be executed that sorts the remaining image data (i.e., the image data with a value less than the global threshold value) in the image data set. In one aspect, the image data can be sorted in ascending order. After sorting the image data set, as in block 318, logic can be executed that provides to the imaging system 300 a black level baseline value from the image data set. The black level baseline value can be provided to the imaging system 300 by calculating a median value from the bottom percentage (e.g., 10%) of the sorted image data.

In one aspect, where image data may be for a video image, the median value derived using the process above can be placed in a first-in-first-out (FIFO) data structure. As subsequent median values are placed in the FIFO data structure, as in block 322, logic may calculate a running average using the median values in the FIFO data structure. In one aspect, for example, a FIFO data structure may contain eight or more median value elements. A final averaged value can then be used as a black level baseline value and output to the imaging system 300.

FIG. 2 and FIG. 3 illustrate that certain processing modules may be discussed in connection with this technology and these processing modules can be implemented as computing services. In one example configuration, a module can be considered a service with one or more processes executing on computer hardware. Such services may be centrally hosted functionality or a service application that can receive requests and provide output to other services. An application program interface (API) can be provided for each module to enable a second module to send requests to and receive output from the first module. Such APIs may also allow third parties to interface with the module and make requests and receive output from the modules. While FIG. 2 and FIG. 3 illustrate an example of an imaging system that may implement the techniques above, many other similar or different environments are contemplated. The example environment discussed and illustrated above are merely representative and not limiting.

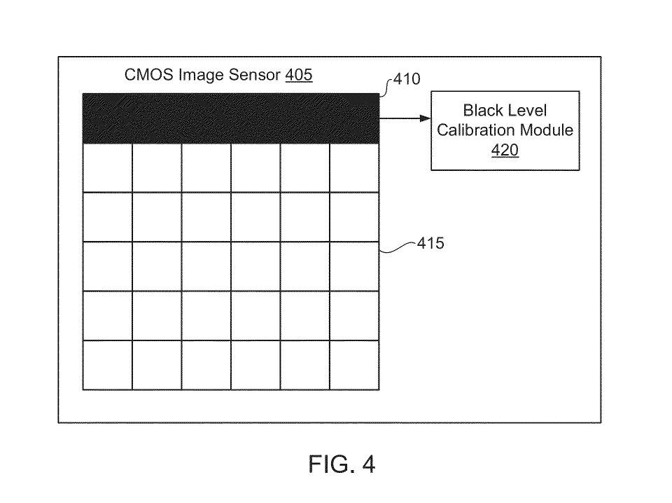

FIG. 4 is a diagram showing one aspect of a CMOS image sensor 405 that includes a black level calibration module 420 located on the CMOS image sensor 405. The CMOS image sensor 405 has an array of active photo sensors or active pixels 415 that capture light and convert the light into electrical signals. A portion of the array of pixels can be shielded from light by, for example, covering the pixels with an opaque material or a thin metal shield. The portion of the array of pixels shielded from light can be used as an optical black pixel region 410 of the CMOS image sensor 405. A black level calibration module 420 located on the CMOS image sensor 405 can receive an image data set from the optical black pixel region 410 that can provide black image data produced by the pixels located in the optical black pixel region 410. The black level calibration module 420 can then calculate a black level baseline value based on the image data set provided by the pixels and then provide the black level baseline value to an imaging system.

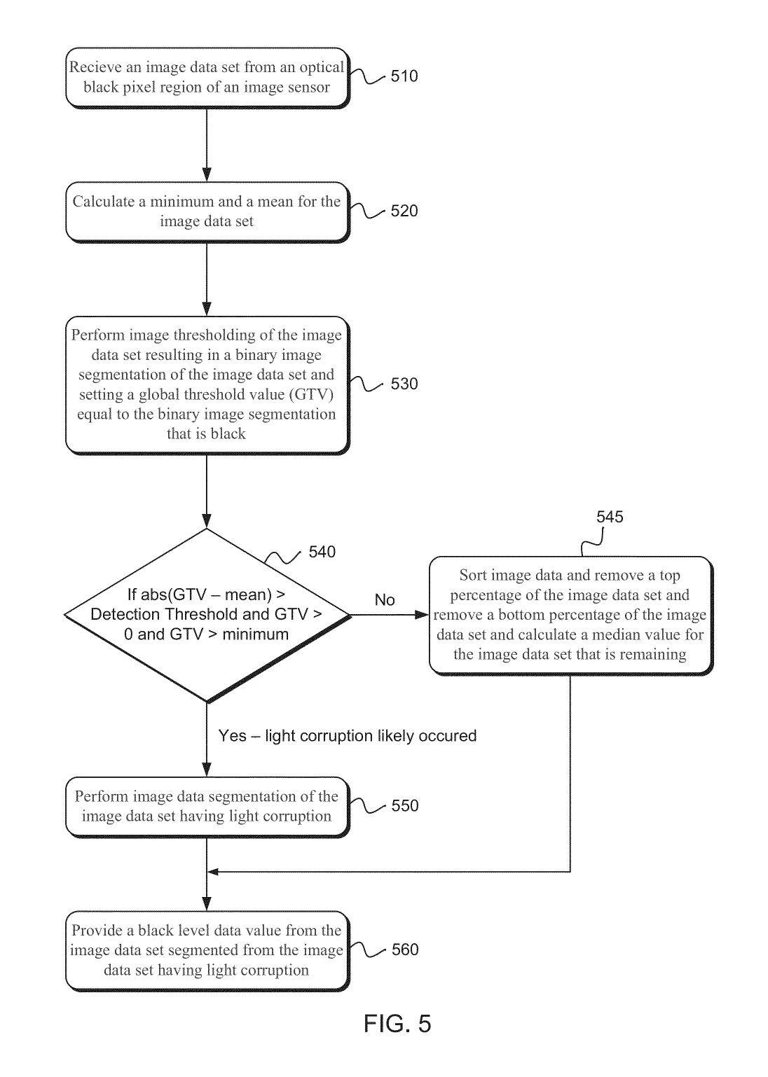

A flow diagram illustrating a black level calibration method is shown in FIG. 5. The black level calibration method illustrated in the flow diagram can be used to provide a black level baseline value to an imaging system. Notably, the method can be applied to a single static image (i.e., a photograph), or in the case of a video image, executed on a per-frame basis or on a predetermined certain number of frames based on sensor implementation and computing resource. The method can be implemented, without limitation, on an image sensor (SOC style), off-chip in the imaging system inside a digital signal processor (DSP), in a field programmable gate array (FPGA), or the like. Additionally, the method can be implemented within a computing environment where an external camera device may be connected to a computing device.

As in block 510, the method may receive an image data set from an optically black pixel region of an image sensor. In one aspect, rather than collecting data from all of the pixels in the optically black pixel region of an image sensor, a portion of the optically black pixels can be selected and data can be collected from the selected optically black pixels. As an example, depending upon computing resources, selecting image data from fewer optically black pixel rows than what may be available may decrease or prevent performance degradation of the imaging system. As described earlier, the optically black pixel region of an image sensor can be an array of pixels that can be covered with a material that shields the pixels from light. Because in some cases strong light may propagate to the optical black pixel region (e.g., through light scattering or internal reflection), the image data set produced by the optically black pixel region can be tested for light corruption using the present technology.

After receiving the image data set, the method can further include calculating a minimum value and a mean value for the image data set, as in block 520. The minimum value and the mean value can be used by the method in determining whether light corruption may exist in the image data set. In one aspect, a maximum value and/or a median value can also be calculated and can be used to determine whether light may have infiltrated the optically black pixel region.

In one aspect of the method, image smoothing with a low pass filter can be performed on the image data set so that noise, such as, for example, temporal noise produced by the optically black pixels can be removed. As one example, a low pass filter such as a 3×3 neighbor image filter can be used to smooth the image data set. Image smoothing can reduce the temporal noise impact on image segmentation techniques used in later operations of the method. One example of a low pass filter can output a value for a center pixel in a 3×3 grid of optically black pixels. The value for the center pixel can be determined by calculating an average of the optically black pixels surrounding the center pixel in the 3×3 pixel grid and the value can then be used as an output value for the pixel.

As in block 530, image thresholding can be performed on the image data set. Image thresholding is a method that transforms an image from a grayscale image to a binary black and white image. Any method that transforms an image into a binary image can be used for image thresholding and is thus considered to be within the present scope. Specific examples of methods that can be used to perform image thresholding include: Otsu's method, balanced histogram thresholding, iterative selection thresholding, and the like. Of course other image thresholding methods may be available for use with the present technology and the present technology is not limited to the specific examples provided above. Image thresholding results in image segmentation, which can simplify an image by reducing the image into fewer data values, making the image easier to analyze. In the present case, the image data set can be segmented into a binary image where image data is represented as either a white pixel or a black pixel. After performing image thresholding on the image data set, a global threshold value can be set to the data value representing the black pixel in the image data set.

As in block 540, light corruption in the image data set can be determined as a function of the global threshold value, the minimum value, the mean value and a detection threshold. The detection threshold is a threshold value used as a comparison value to indicate that a light corruption exists in an image data set. The detection threshold can be tuned for various types of image sensors. For example, the detection threshold value can be based on an image sensor's pixel type, pixel size, varying pixel processes or pixel stack height. In addition, an image sensor's substrate thickness or texture of black silicone can be used to base the detection threshold value. Further, testing varying image sensors under various light conditions can determine the detection threshold.

In one example configuration, a function to determine light corruption can be expressed as:

(|global threshold value|−mean value)>detection threshold

and (global threshold value>0)

and (global threshold value>minimum value))

If all of the above conditions are met, then light corruption exists in the image data set. If the above conditions are not all met, then light corruption has not been detected in the image data set.

In the case that light corruption is detected in the image data set, then, as in block 550, image data segmentation of the image data set can be performed. In one aspect, image data segmentation can include segmenting the image data in an image data set that is greater than the global threshold value from the remaining image data in the image data set. The image data that is greater than the global threshold value can then be excluded from further calculations. In another aspect, the image data set can be segmented by removing image data with values greater than the global threshold value from the image data set, thus leaving only image data with values less than the global threshold value in the image data set.

After segmenting the image data in the image data set, a black level baseline value can be provided to an imaging system, as in block 560, by sorting the image data in the image data set and calculating a median value from a bottom percentage of the sorted image data set. In one aspect, for example, the image data can be sorted in ascending order and a median value can be calculated from a bottom 10% of the sorted image data set. In another aspect, the bottom percentage of the sorted image data set can be selected from a range of about 10% to about 20% of the image data set. Of course these percentages are merely representative of a range of percentages that can be used to calculate a median value and therefore do not limit the present technology to a stated percentage. Upon calculating a median value from the bottom percentage of the sorted image data set, the median value can then be provided to the imaging system to be used as a black level baseline value. The black level baseline value can be in some cases tuned (i.e., adjusted) based on a sensor image type and upon an application (i.e., software) that may be utilizing the black level baseline value.

In the case where the results of the function to determine light corruption indicate that no light corruption exists in the image data set, then as in block 545, the image data set can be sorted and a top percentage and a bottom percentage of the image data set can be removed. After removing the top percentage and bottom percentage, a median value can be calculated from the image data remaining in the image data set. For example, a top 5% of image data and a bottom 5% of image data can be removed from the image data set and a median value can be calculated from the center 90% of the image data set. In one aspect, the top percentage of the image data selected for removal from the image data set can be a range of about 5% to about 10% and the bottom percentage of the image data selected from removal can also be a range of about 5% to about 10% of the bottom image data in the image data set. The median value can then be provided to an imaging system and used as a black level baseline value. As stated previously, the black level baseline value provided by the method can be tuned based upon a sensor image type and also based on a type of software that utilizes the black level baseline value.

In some aspects of the present technology, the method can be performed for a single static image (i.e., a photograph), and in other aspects the method can be performed for a video image. In one aspect, the method can calibrate a black level for each frame of a video image, and in another aspect, the method can calibrate a black level for a predetermined number of frames for a video image. As an example, the method can provide a black level baseline value for every tenth frame of a video image. For those aspects where the method calculates a black level baseline value for a video image, a running average of the black level baseline value can be calculated.

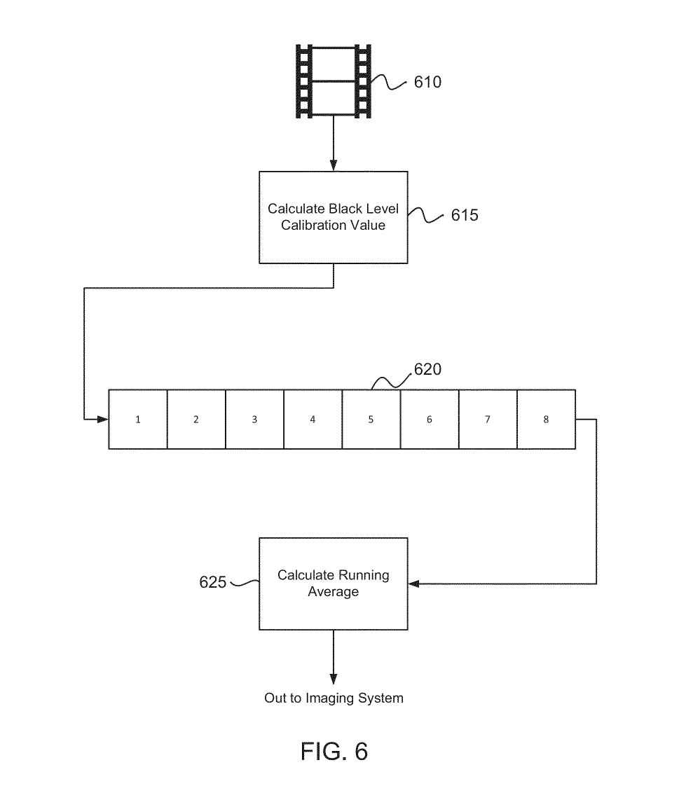

As shown in FIG. 6, an example of a method that produces a running average is illustrated. A video image data set 610 can be provided to the method described in FIG. 5 and a black level baseline value can be calculated 615 for the video image data set 610. The black level baseline value can then be placed in a first-in-first-out (FIFO) data structure 620. The FIFO data structure 620 can have a number of elements, from which an element can be retrieved and used to calculate a running average 625. The running average can be provided to the imaging system and used as a black level baseline value. For example, providing a running average to an imaging system can reduce or eliminate fluctuations in brightness for a video image as the video image is played. As will be appreciated, any number of elements can be included in a FIFO data structure (i.e., two or more) and the FIFO data structure depicted in FIG. 6 is merely an example of a FIFO data structure that can be used to temporarily store a black level baseline value.

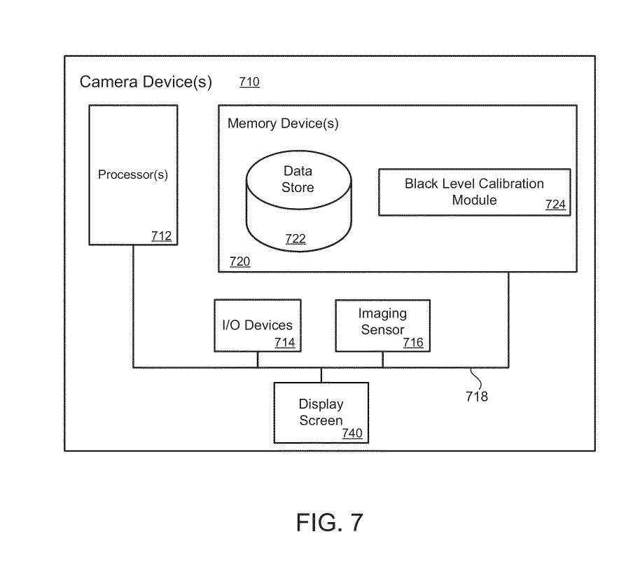

FIG. 7 illustrates a high level example of a camera device 710 on which modules of this technology may execute. The camera device 710 can include one or more processors 712 that are in communication with one or more memory devices 720. The camera device 710 may include a local communication interface 718 for the components in the camera device. For example, the local communication interface may be a local data bus and/or any related address or control busses as may be desired.

The memory device 720 can contain modules that are executable by the processor(s) 712 and data for the modules. Located in the memory device 720 are services and modules executable by the processor. For example, a black level calibration module 724 and other modules may be located in the memory device 720. The modules can execute the functions described earlier. A data store 722 can also be located in the memory device 720 for storing data related to the modules and other applications along with an operating system that is executable by the processor(s) 712.

Other applications can also be stored in the memory device 720 and can be executable by the processor(s) 712. Components or modules described herein can be implemented in the form of software using high programming level languages that are compiled, interpreted or executed using a hybrid of the methods.

The camera device 710 can also have access to I/O (input/output) devices 714 that are usable by the camera device 710. An example of an I/O device is a display screen 740 that is available to display output (i.e., photographs or video) from the camera device. Other known I/O devices can be used with the camera device as desired. The camera device 710 can include an imaging sensor 716 or an active-pixel sensor that is comprised of an integrated circuit containing an array of pixel sensors, where each pixel can contain a photodetector and an active amplifier. Examples of the present technology can be executed within a module that is integrated into the imaging sensor 716.

The components or modules that are shown as being stored in the memory device 720 can be executed by the processor(s) 712. The term “executable” can mean a program file that is in a form that can be executed by a processor 712. For example, a program in a higher level language can be compiled into machine code in a format that can be loaded into a random access portion of the memory device 720 and executed by the processor 712, or source code can be loaded by another executable program and interpreted to generate instructions in a random access portion of the memory to be executed by a processor. The executable program can be stored in any portion or component of the memory device 720. For example, the memory device 720 can be random access memory (RAM), read only memory (ROM), flash memory, a solid state drive, memory card, a hard drive, optical disk, floppy disk, magnetic tape, or any other memory components.

The processor 712 can represent multiple processors and the memory devices 720 can represent multiple memory units that operate in parallel to the processing circuits. This can provide parallel processing channels for the processes and data in the system. The local interface 718 can be used as a network to facilitate communication between any of the multiple processors and multiple memories. The local interface 718 can use additional systems designed for coordinating communication such as load balancing, bulk data transfer and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like.

Modules can also be implemented in software for execution by various types of processors. An identified module of executable code can, for instance, comprise one or more blocks of computer instructions, which can be organized as an object, procedure, or function. Nevertheless, the executables of an identified module need not be physically located together, but can comprise disparate instructions stored in different locations which comprise the module and achieve the stated purpose for the module when joined logically together.

Indeed, a module of executable code can be a single instruction, or many instructions and can even be distributed over several different code segments, among different programs and across several memory devices. Similarly, operational data can be identified and illustrated herein within modules and can be embodied in any suitable form and organized within any suitable type of data structure. The operational data can be collected as a single data set, or can be distributed over different locations including over different storage devices. The modules can be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium that can be used to store the desired information and described technology.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A method for calibrating a black level in an image sensor, comprising:
under control of a processor and memory configured with executable instructions, receiving an image data set from an optical black pixel region of an image sensor, calculating a minimum and a mean for the image data set;
performing image thresholding of the image data set resulting in a binary image segmentation of the image data set and setting a global threshold value equal to the binary image segmentation that is black;
determining light corruption as a function of the global threshold value, the minimum, the mean, and a detection threshold, wherein the detection threshold is determined by light conditions that result in light corruption;
performing image data segmentation of the image data set having light and
providing a black level baseline value from the image data set segmented from the image data set having light corruption.

2. A method as in claim 1, wherein segmentation of the image data set having light corruption comprises removing image data having a value greater than the global threshold value from the image data set.

3. A method as in claim 2, further comprising sorting the image data set in ascending order and calculating a black level median value using a bottom percentage of the image data set.

4. A method as in claim 3, further comprising placing the black level median value into a first-in-first-out (FIFO) data structure and calculating a running average value for a plurality of subsequent black level median values in the first-in-first-out data structure, wherein the running average value is provided as a black level baseline value.

5. A method as in claim 3, wherein the black level median value is adjusted based at least on part of a type of sensor used to capture the image data set and a type of software utilizing the black level median value.

6. A method as in claim 3, wherein the bottom percentage of the image data set is a range of about 10% to about 20% of the image data set.

7. A method as in claim 1, further comprising where no light corruption is detected in the image data set, sorting in ascending order the image data set;
removing a top percentage of the image data set;
removing a bottom percentage of the image data set; and
calculating a median value for the image data set that is remaining after removing the top percentage and the bottom percentage of the image data set.

8. A method as in claim 7, wherein the top percentage of the image data set is a range of about a top 5% to about 20% of the image data set and the bottom percentage of the image data set is a range of about the bottom 5% to about 20% of the image data set.

9. A method as in claim 1, further comprising calibrating a black level for each frame of a video image.

10. A method as in claim 1, further comprising calibrating a black level for a predetermined number of frames for a video image.

11. A method as in claim 1, wherein the image data set is image data from a single static image.

12. A method as in claim 1, wherein the image data set is received from a pre-selected optical black pixel region of the image sensor.

13. A method as in claim 1, wherein the image sensor is a complementary metal-oxide semiconductor (CMOS) sensor.

14. A method as in claim 1, further comprising performing image smoothing of the image data set with a low pass filter prior to performing image thresholding of the image data set.

15. A method as in claim 1, wherein performing image thresholding of the image data set reduces the image data set to a binary image.

16. A method as in claim 1, wherein determining light corruption as a function of the global threshold value further comprises indicating light corruption in the optically black region when:
an absolute global threshold value minus the mean is greater than the detection threshold; and
the global threshold value is greater than zero; and
the global threshold value is greater than the minimum value.

17. A method as in claim 16, wherein the detection threshold is a value that is adjusted for different types of sensors.

18. A method as in claim 1, further comprising calculating value and a median value for the image data set.

19. A non-transitory machine readable storage medium, including program code, when executed to cause a machine to perform the method of claim 1.

20. An imaging system for calibrating black levels in image sensors, comprising:
an image sensor accessible to a processor from which an image data set is received;
a memory device including instructions that, when executed by the processor, cause the processor to execute:
a black level calibration module that is executable in the camera system, the black level calibration module comprising;
logic operable to calculate a minimum and a mean for the image data set received from an optical black pixel region of the image sensor;
logic operable to perform image thresholding of the image data set that results in a binary image segmentation of the image data set and sets a global threshold value equal to the binary image segmentation that is black;
logic operable to determine light corruption as a function of the global threshold value, the minimum, the mean, and a detection threshold;
logic operable to perform image data segmentation of the image data set having light corruption and removing image data having a value greater than the global threshold value from the image data set; and
logic operable to provide to the imaging system a black level baseline value from the image data segmented from the image data set having light corruption.

21. An imaging system as in claim 20, further comprising logic operable to sort the image data set in ascending order and calculating a black level median value using a bottom percentage of the image data set.

22. An imaging system as in claim 21, further comprising logic operable to place the black level median value into a first-in-first-out (FIFO) data structure and calculate a running average value for a plurality of subsequent black level median values contained in the first-in-first-out data structure producing a black level baseline value.

23. An imaging system as in claim 20, further comprising a camera housing operable to house the camera system within the camera housing.

24. A method for calibrating black levels in image sensors, comprising:
under control of a processor and memory configured with executable instructions,
receiving an image data set from a preselected optical black pixel region of an image sensor;
calculating a maximum, a minimum, a mean and a median for the image data set;
performing image smoothing of the image data set with a low pass filter;
performing image thresholding of the image data set resulting in a binary image segmentation of the image data set and setting a global threshold value equal to the binary image segmentation that is black;
determining light corruption as a function of the global threshold value, the maximum, the minimum, the mean and the median image data, and a detection threshold;
performing image data segmentation of the image data set having light corruption and removing image data having a value greater than the global threshold value from the image data set;
sorting the image data set in ascending order and calculating a black level median value using a bottom percentage of the image data set; and
placing the black level median value into a first-in-first-out (FIFO) data structure and calculating a running average value for a plurality of subsequent black level median values in the first-in-first-out data structure, wherein the running average value is provided as a black level baseline value.
